(19) United States
(12) Patent Application Publication
(10) Pub. No.: US 2024/0061424 A1
(43) Pub. Date: Feb. 22, 2024

(54) VEHICLE AND CONTROL METHOD INCORPORATING SENSOR FUSION

(71) Applicants: Hyundai Motor Company, Seoul (KR); Kia Corporation, Seoul (KR)

(72) Inventors: Eungseo Kim, Gwacheon (KR); Dong Hyun Sung, Hwaseong (KR); Yongseok Kwon, Suwon (KR); Tae-Geun An, Yeongju (KR); Hyoungjong Wi, Seoul (KR); Joon Ho Lee, Seoul (KR); Dae Seok Jeon, Hwaseong (KR); Sangmin Lee, Seoul (KR)

(21) Appl. No.: 18/218,674

(22) Filed: Jul. 6, 2023

(30) Foreign Application Priority Data
Aug. 18, 2022 (KR) 10-2022-0103656

(51) Int. Cl. G05D 1/00; B60W 30/09

(52) U.S. Cl. CPC G05D 1/0088; B60W 30/09; B60W 2420/52; G05D 2201/0213

(57) ABSTRACT

A vehicle includes a camera provided to obtain image data, radar provided to obtain radar data, Lidar provided to obtain Lidar data, and a controller configured to process the image data, the radar data, and the Lidar data to generate a first sensor fusion track, where the controller calculates reliability of at least one sensor in which an event does not occur among a plurality of sensors including the camera, the radar and the Lidar when the event for the sensor is detected, and changes from the first sensor fusion track to a second sensor fusion track based on the at least one sensor when the reliability is greater than or equal to a predetermined threshold, and where the controller is configured to control a braking amount or a deceleration amount of the vehicle based on the first sensor fusion track or the second sensor fusion track.

### CROSS-REFERENCE TO RELATED APPLICATION(S)

This application is based on and claims priority under 35 U.S.C. § 119 the benefit of Korean Patent Application No. 10-2022-0103656, filed on Aug. 18, 2022 in the Korean Intellectual Property Office, the entire contents of which are incorporated by reference herein.

### BACKGROUND

### 1. Technical Field

The present disclosure relates to a vehicle and a control method thereof, more particularly, to the vehicle and control method incorporating sensor fusion to improve object tracking that is capable of securing redundancy in sensor fusion.

### 2. Description of the Related Art

An autonomous vehicle may be configured to recognize a road environment, determine a driving situation, and move from a current location to a target location along a planned driving route.

For example, the autonomous vehicle may include a sensor fusion device that is configured to recognize other vehicles, obstacles, roads, etc. through a combination of various sensors such as a camera, radar and Lidar.

In a specific situation, when at least one of the sensors of the sensor fusion device does not recognize an object, a control malfunction may occur. Therefore, it would be desirable to secure redundancy for continuously detecting an object even when any one of the sensors of the sensor fusion device fails.

### SUMMARY

The present disclosure provides a vehicle and a control method thereof capable of securing redundancy in sensor fusion.

Additional aspects of the present disclosure will be set forth in part in the description which follows and, in part, will be obvious from the description, or may be learned by practice of the present disclosure.

In accordance with an aspect of the present disclosure, a vehicle includes a camera provided to obtain image data, a radar provided to obtain radar data, a Lidar provided to obtain Lidar data, and a controller configured to process the image data, the radar data, and the Lidar data to generate a first sensor fusion track, wherein the controller calculates reliability of at least one sensor in which an event does not occur among a plurality of sensors including the camera, the radar and the Lidar when the event for the at least one sensor is detected, and changes from the first sensor fusion track to a second sensor fusion track based on the at least one sensor when the reliability is greater than or equal to a predetermined threshold, where the controller is configured to control a braking amount or a deceleration amount of the vehicle based on the first sensor fusion track or the second sensor fusion track.

The controller may limit at least one of the braking amount and the deceleration amount of the vehicle to a predetermined ratio when the second sensor fusion track is generated.

The controller may detect an event for the camera and generate the second sensor fusion track based on the radar data and the Lidar data.

The controller may generate the event for the camera based on illuminance or external weather conditions.

The controller may detect an event for the radar and generate the second sensor fusion track based on the image data and the Lidar data.

The controller may occur the event based on a connection state between the radar and the controller.

The controller may detect an event for the Lidar and generate the second sensor fusion track based on the image data and the radar data.

The controller may occur the event based on a connection state between the radar and the controller.

The controller may detect an event for the camera and the radar, and generate the second sensor fusion track based on the Lidar data.

The controller may detect an event for the radar and the Lidar, and generate the second sensor fusion track based on the image data.

The controller may detect an event for the camera and the Lidar, and generate the second sensor fusion track based on the image data.

The controller may obtain a size of an object in front of the vehicle based on at least one of the image data and the Lidar data when the camera or the Lidar is included in the at least one sensor in which the event does not occur, and limit at least one of a braking amount and a deceleration amount of the vehicle to a predetermined ratio when the size of the object is greater than or equal to a predetermined size.

The controller may perform avoidance control for an object based on the second sensor fusion track.

The event may include a situation in which a preceding vehicle traveling in a field of front view of the vehicle disappears and an object in front of the preceding vehicle is detected.

In accordance with an aspect of the present disclosure, a control method of a vehicle which includes a camera provided to obtain image data, a radar provided to obtain radar data, and a Lidar provided to obtain Lidar data, includes the following steps performed by a controller: processing the image data, the radar data, and the Lidar data to generate a first sensor fusion track, detecting an event for at least one of a plurality of sensors including the camera, the radar and the Lidar, calculating reliability of at least one sensor among the plurality of sensors in which the event does not occur; changing from the first sensor fusion track to a second sensor fusion track based on the at least one sensor when the reliability is greater than or equal to a predetermined threshold; and controlling a braking amount or a deceleration amount of the vehicle based on the first sensor fusion track or the second sensor fusion track.

The control method may further include limiting at least one of the braking amount and the deceleration amount of the vehicle to a predetermined ratio when the second sensor fusion track is generated.

The changing to the second sensor fusion track may include detecting an event for the camera and generating the second sensor fusion track based on the radar data and the Lidar data.

The detecting of the event for the camera may include generating an event for the camera based on illuminance or external weather conditions.

The changing to the second sensor fusion track may include detecting an event for the radar and generating the second sensor fusion track based on the image data and the Lidar data.

The detecting of the event for the radar may include detecting the event based on a connection state between the radar and a controller.

In accordance with an aspect of the present disclosure, a non-transitory computer readable medium containing program instructions executed by a processor includes: program instructions that process image data, radar data, and Lidar data to generate a first sensor fusion track; program instructions that detect an event for at least one of a plurality of sensors comprising a camera, a radar and a Lidar; program instructions that calculate reliability of at least one sensor among the plurality of sensors in which the event does not occur; program instructions that change from the first sensor fusion track to a second sensor fusion track based on the at least one sensor when the reliability is greater than or equal to a predetermined threshold; and program instructions that control a braking amount or a deceleration amount of the vehicle based on the first sensor fusion track or the second sensor fusion track.

### BRIEF DESCRIPTION OF THE DRAWINGS

These and/or other aspects of the present disclosure will become apparent and more readily appreciated from the following description of the embodiments of the present disclosure, taken in conjunction with the accompanying drawings of which:

FIG. 1 illustrates a control block diagram of a vehicle according to an embodiment of the present disclosure;

FIG. 2 illustrates a sensor fusion track of a camera, radar and Lidar included in the vehicle according to an embodiment of the present disclosure;

FIG. 3 is a flowchart of a control method of the vehicle according to an embodiment of the present disclosure;

FIG. 4 is a flowchart of a control method of the vehicle in which radar and Lidar are excluded from the sensor fusion track;

FIG. 5 is a flowchart of a control method of the vehicle in which radars is excluded from the sensor fusion tracks;

FIG. 6 is a flowchart of a control method of the vehicle in which the camera is excluded from the sensor fusion track;

FIG. 7 is a flowchart of a control method of the vehicle in which the camera and radars are excluded from the sensor fusion track;

FIG. 8 is a flowchart of a control method of the vehicle in which the camera and Lidar are excluded from the sensor fusion track; and

FIG. 9 is a table illustrating reliability and a control level for each sensor fusion combination.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Throughout the specification, when an element is referred to as being located “on” or “over” another element, this includes not only a case in which an element is in contact with another element but also a case in which another element exists between the two elements.

The terms ‘first,’ ‘second,’ etc. are used to distinguish one element from another element, and the elements are not limited by the above-mentioned terms.

In each step, an identification numeral is used for convenience of explanation, the identification numeral does not describe the order of the steps, and each step may be performed differently from the order specified unless the context clearly states a particular order.

Hereinafter, a principle of action and embodiments of the present disclosure will be described with reference to the accompanying drawings.

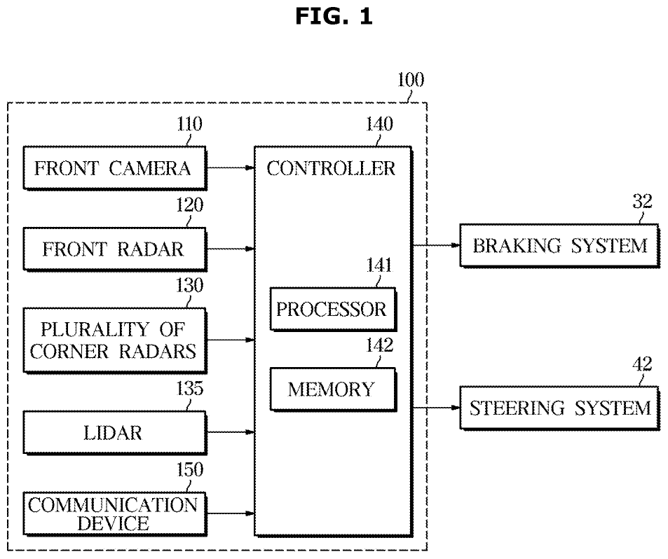

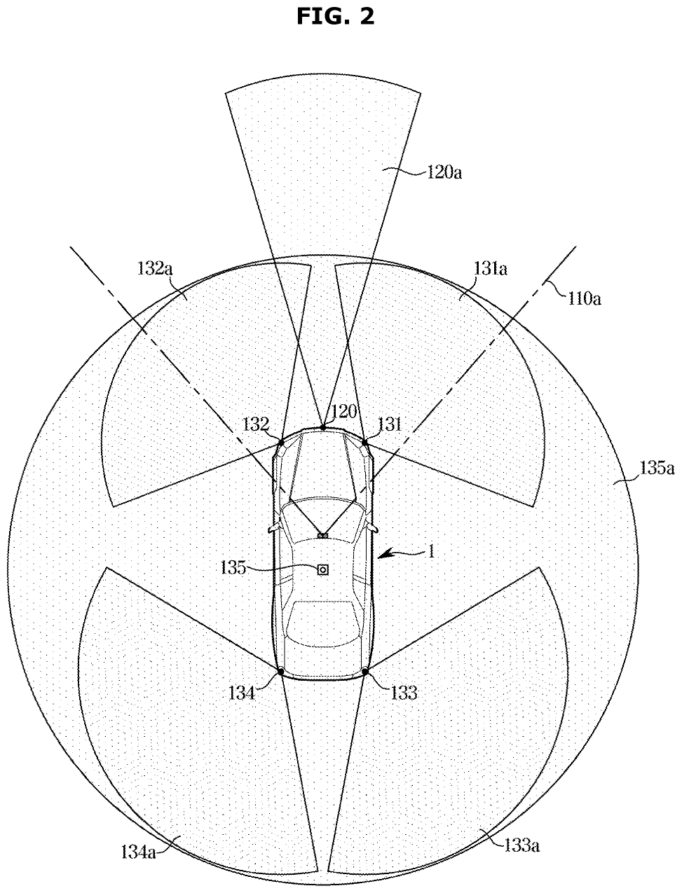

FIG. 1 illustrates a control block diagram of a vehicle according to an embodiment of the present disclosure, and FIG. 2 illustrates a sensor fusion track of a camera, radar and Lidar included in the vehicle according to an embodiment of the present disclosure, e.g., the embodiment depicted in FIG. 1.

As provided herein, sensor fusion refers to associating sensing information obtained from multiple sensors (e.g., the camera, radar, and/or Lidar) to interpret external conditions for detecting one or more objects, and a sensor fusion track refers to tracking of the one or more objects using the associated sensing information.

Embodiments according to the present disclosure may be applied not only to a vehicle with an internal combustion engine that obtains power from an engine, but also to an electric vehicle (EV) or hybrid electric vehicle (HEV) provided with an autonomous driving function.

Referring to FIG. 2, a vehicle 1 may include a plurality of electronic components. For example, the vehicle 1 may include an engine management system (EMS), a transmission control unit (TCU), an electronic brake control module, an electronic power steering (EPS), a body control module (BCM), and an autonomous driving system 100 (see FIG. 1).

The autonomous driving system 100 may assist a driver to operate (drive, brake, and steer) the vehicle 1. For example, the autonomous driving system 100 may detect an environment (e.g., another vehicle, a pedestrian, a cyclist, a lane, a road signpost, a traffic light, etc.) of a road on which the vehicle 1 is traveling, and may control driving, braking, and/or steering of the vehicle 1 in response to the detected environment.

As another example, the autonomous driving system 100 may receive a high definition map at a current location of the vehicle 1 from an external server, and may control driving, braking, and/or steering of the vehicle 1 in response to the received high definition map.

The autonomous driving system 100 may include a camera (e.g., a front camera) 110 provided to obtain image data around the vehicle 1, various types of radar (e.g., a front radar and/or corner radar(s)) 120 and 130 provided to obtain radar data around the vehicle 1, and a Lidar 135 provided to scan the surroundings of the vehicle 1 and detect an object. The camera 110 may be connected to an electronic control unit (ECU) to photograph the front of the vehicle 1 and recognize another vehicle, a pedestrian, a cyclist, a motorcycle, a lane, a road signpost, a structure, and the like. The radars 120 and 130 may be connected to the electronic control unit to obtain relative positions and relative speeds of objects (e.g., other vehicles, pedestrians, cyclists, motorcycles, structures, etc.) around the vehicle 1.

The Lidar 135 may be connected to the electronic control unit to obtain a relative position and relative speed of a moving object (e.g., another vehicle, a pedestrian, a cyclist, etc.) around the vehicle 1. Also, the Lidar 135 may obtain a shape and position of a fixed object (e.g., a building, a signpost, a traffic light, a bump, etc.) around the vehicle 1.

Specifically, the Lidar 135 may obtain a shape and position of a fixed object around the vehicle 1 by obtaining point cloud data for a field of external view of the vehicle 1.

That is, the autonomous driving system 100 may process the image data obtained from the camera 110, the radar data obtained from the radars 120 and 130, and the point cloud data obtained from the Lidar 135, and detect an environment of a road on which the vehicle 1 is traveling, a front object located in front of the vehicle 1, a lateral object located on a side of the vehicle 1, and a rear object located behind the vehicle 1, in response to the processing of the image data, the detection data, and the point cloud data.

The autonomous driving system 100 may include a communication device 150 provided to receive the high definition map at the current location of the vehicle 1 from a cloud server.

The communication device 150 may be implemented using a communication chip, an antenna, and related components to access a wireless communication network. That is, the communication device 150 may be implemented with various types of communication modules capable of long-distance communication with an external server. That is, the communication device 150 may include a wireless communication module for wirelessly transmitting and receiving data with an external server.

The above electronic components may communicate with each other through a vehicle communication network NT. For example, the electronic components may transmit and receive data through an Ethernet, a media oriented systems transport (MOST), Flexray, a controller area network (CAN), and a local interconnect network (LIN).

As illustrated in FIG. 1, the vehicle 1 may include a braking system 32, a steering system 42, and the autonomous driving system 100.

The braking system 32 and the steering system 42 may control the vehicle 1 so that the vehicle 1 performs autonomous driving based on a control signal of the autonomous driving system 100.

The autonomous driving system 100 may include the front camera 110, the front radar 120, a plurality of the corner radars 130, the Lidar 135, and the communication device 150.

As illustrated in FIG. 2, the front camera 110 may have a field of view 110a facing the front of the vehicle 1. The front camera 110 may be installed, for example, on a front windshield of the vehicle 1, but may be provided at any location without limitation as long as it has a field of view facing the front of the vehicle 1.

The front camera 110 may photograph the front of the vehicle 1 and obtain image data of the front of the vehicle 1. The image data of the front of the vehicle 1 may include a location with respect to a road boundary line located in front of the vehicle 1.

The front camera 110 may include a plurality of lenses and an image sensor. The image sensor may include a plurality of photodiodes for converting light into an electrical signal, and the plurality of photodiodes may be arranged in a two-dimensional matrix.

The front camera 110 may be electrically connected to a controller 140. For example, the front camera 110 may be connected to the controller 140 through the vehicle communication network NT, or connected to the controller 140 through a hard wire, or connected to the controller 140 through a printed circuit board (PCB).

The front camera 110 may transmit the image data of the front of the vehicle 1 to the controller 140.

As illustrated in FIG. 2, the front radar 120 may have a field of sensing 120a facing the front of the vehicle 1. The front radar 120 may be installed, for example, on a grille or a bumper of the vehicle 1.

The front radar 120 may include a transmission antenna (or a transmission antenna array) for emitting a transmission wave toward the front of the vehicle 1, and a reception antenna (or a reception antenna array) for receiving a reflected wave reflected from an object. The front radar 120 may obtain the radar data from the transmission wave transmitted by the transmission antenna and the reflected wave received by the reception antenna. The radar data may include distance information and speed information about another vehicle or a pedestrian or a cyclist located in front of the vehicle 1. The front radar 120 may calculate a relative distance to the object based on a phase difference (or time difference) between the transmission wave and the reflected wave, and calculate a relative speed of the object based on a frequency difference between the transmission wave and the reflected wave.

The front radar 120 may be connected to the controller 140 through, for example, the vehicle communication network NT, the hard wire, or the printed circuit board. The front radar 120 may transmit front radar data to the controller 140.

The plurality of corner radars 130 preferably includes a first corner radar 131 installed on a front right side of the vehicle 1, a second corner radar 132 installed on a front left side of the vehicle 1, a third corner radar 133 installed on a rear right side of the vehicle 1, and a fourth corner radar 134 a rear left side of the vehicle 1.

As illustrated in FIG. 2, the first corner radar 131 may have a field of sensing 131a facing the front right side of the vehicle 1. The first corner radar 131 may be installed, for example, on the right side of a front bumper of the vehicle 1. The second corner radar 132 may have a field of sensing 132a facing the front left side of the vehicle 1, and may be installed, for example, on the left side of the front bumper of the vehicle 1. The third corner radar 133 may have a field of sensing 133a facing the rear right side of the vehicle 1, and may be installed, for example, on the right side of a rear bumper of the vehicle 1. The fourth corner radar 134 may have a field of sensing 134a facing the rear left side of the vehicle 1, and may be installed, for example, on the left side of the rear bumper of the vehicle 1.

Each of the first, second, third, and fourth corner radars 131, 132, 133, and 134 may include a transmission antenna and a reception antenna. The first, second, third, and fourth corner radars 131, 132, 133, and 134 may obtain first corner detection data, second corner detection data, third corner detection data, and fourth corner detection data, respectively. The first corner detection data may include distance information and speed information about another vehicle or a pedestrian or a cyclist or a structure (hereinafter referred to as “object”) located on the front right side of the vehicle 1. The second corner detection data may include distance information and speed information of an object located on the front left side of the vehicle 1. The third and fourth corner detection data may include distance information and relative speeds of objects located on the rear right side of the vehicle 1 and the rear left side of the vehicle 1.

Each of the first, second, third, and fourth corner radars 131, 132, 133, and 134 may be connected to the controller 140 through, for example, the vehicle communication network NT, the hard wire, or the printed circuit board. The first, second, third, and fourth corner radars 131, 132, 133, and 134 may transmit the first, second, third, and fourth corner detection data to the controller 140, respectively.

The Lidar 135 may obtain a relative position, relative speed, etc. of a moving object (e.g., another vehicle, a pedestrian, a cyclist, etc.) around the vehicle 1. Also, the Lidar 135 may obtain a shape and position of a surrounding fixed object (e.g., a building, a signpost, a traffic light, a bump, etc.). The Lidar 135 may be installed in the vehicle 1 to have a field of external view 135a of the vehicle 1, and obtain point cloud data for the field of external view 135a of the vehicle 1.

For example, as illustrated in FIG. 2, the Lidar 135 may be provided outside the vehicle 1 to have the field of external view 135a of the vehicle 1, and more specifically, may be provided on a roof of the vehicle 1.

The Lidar 135 may include a light emitting part provided to emit light, a light receiving part provided to receive a light beam in a preset direction among reflected light beams when the light emitted from the light emitting part is reflected from an obstacle, and a printed circuit board to which the light emitting part and the light receiving part are fixed. In this case, the printed circuit board is provided on a support plate that is rotated by a rotation diving part so as to be rotated 360 degrees in a clockwise or counterclockwise direction.

That is, the support plate may rotate about an axis according to the power transmitted from the rotation driving part, and the light emitting part and the light receiving part are fixed to the printed circuit board so as to be rotated 360 degrees in the clockwise or counterclockwise direction together with the rotation of the printed circuit board. Through this, the Lidar 135 may detect an object in all directions 135a by emitting and receiving light at 360 degrees.

The light emitting part is a component that emits light (e.g., an infrared laser), and may be provided singly or in plurality according to an embodiment of the present disclosure.

The light receiving part is provided to receive a light beam in the preset direction among the reflected light beams when the light emitted from the light emitting part is reflected from an obstacle. An output signal generated as the light is received by the light receiving part may be provided to an object detection process of the controller 140.

The light receiving part may include a condensing lens for condensing the received light and an optical sensor for detecting the received light. According to an embodiment of the present disclosure, the light receiving part may include an amplifier for amplifying the light detected by the optical sensor.

The Lidar 135 may receive data about plenty of points on outer surfaces of an object, and may obtain the point cloud data, which is a set of data for these points.

The controller 140 may include a processor 141 and a memory 142.

The processor 141 may process the image data of the front camera 110 and the radar data of the front radar 120, and generate a braking signal and a steering signal for controlling the braking system 32 and the steering system 42. Also, the processor 141 may calculate a distance between the vehicle 1 and a right road boundary line (hereinafter ‘first distance’) and a distance between the vehicle 1 and a left road boundary line (hereinafter ‘second distance’) in response to the processing of the image data of the front camera 110 and the radar data of the front radar 120.

As a method of calculating the first distance and the second distance, a conventional image data processing technique and/or a radar/Lidar data processing technique may be used.

The processor 141 may process the image data of the front camera 110 and the radar data of the front radar 120, and detect objects (e.g., lanes and structures) in front of the vehicle 1 in response to the processing of the image data and the radar data.

Specifically, the processor 141 may obtain positions (distances and directions) and relative speeds of objects in front of the vehicle 1 based on the radar data obtained by the front radar 120. The processor 141 may obtain position (direction) and type information (e.g., whether the object is another vehicle or a structure, etc.) of the objects in front of the vehicle 1 based on the image data of the front camera 110. The processor 141 may also match the objects detected by the image data to the objects detected by the radar data, and may obtain type information, positions, and relative speeds of the objects in front of the vehicle 1 based on a matching result.

As described above, the processor 141 may obtain information related to an environment of a road on which the vehicle 1 is traveling and a front object, and calculate a distance between the vehicle 1 and the right road boundary line and a distance between the vehicle 1 and the left road boundary line.

The road boundary line may refer to a boundary line of a structure such as a guard rail, opposite ends of a tunnel, and an artificial wall, through which the vehicle 1 may not physically pass, and may refer to a center line through which the vehicle 1 may not pass in principle, but is not limited thereto.

The processor 141 may process the high definition map received from the communication device 150, and calculate a distance between the vehicle 1 and a right road boundary line (hereinafter, ‘third distance’) and a distance between the vehicle 1 and a left road boundary line (hereinafter, ‘fourth distance’), in response to the processing of the high definition map.

Specifically, the processor 141 may receive the high definition map at the current location of the vehicle 1 based on the current location of the vehicle 1 obtained from a GPS, and determine the location of the vehicle 1 on the high definition map based on the image data and the radar data.

For example, the processor 141 may determine a road on which the vehicle 1 is traveling on the high definition map based on the location information of the vehicle 1 obtained from the GPS, and determine a lane in which the vehicle 1 is traveling based on the image data and the radar data. That is, the processor 141 may determine coordinates of the vehicle 1 on the high definition map.

For example, the processor 141 may determine the number of left lanes in response to the processing of the image data and radar data, determine a location of the lane in which the vehicle 1 is traveling on the high definition map based on the determined number of left lanes, and thus specifically determine the coordinates of the vehicle 1 on the high definition map, but the method of determining the coordinates of the vehicle 1 on the high definition map is not limited thereto.

That is, the processor 141 may also determine the coordinates of the vehicle 1 on the high definition map based on the number of right lanes detected based on the image data and the radar data, and determine the coordinates of the vehicle 1 on the high definition map based on the first distance and the second distance calculated based on the image data and the radar data.

For this purpose, the processor 141 may include an image processor for processing image data of the front camera 110 and high definition map data and/or a digital signal processor for processing detection data of the front radar 120 and/or a micro control unit (MCU) or domain control unit (DCU) for generating control signals for controlling the braking system 32 and the steering system 42.

The memory 142 may store a program and/or data for the processor 141 to process image data and high definition map data, a program and/or data for processing detection data, and a program and/or data for the processor 141 to generate a braking signal and/or a steering signal.

The memory 142 may temporarily store the image data received from the front camera 110 and/or the detection data received from the radar 120 and the high definition map received from the communication device 150, and may temporarily store a processing result of the image data and/or detection data of the processor 141.

The memory 142 may also permanently store or semi-permanently store the image data received from the front camera 110 and/or the detection data received from the radars 120 and 130 and/or the high definition map received from the communication device 150, according to a signal from the processor 141.

For this purpose, the memory 142 includes not only a volatile memory such as a S-RAM and a D-RAM, but also a non-volatile memory such as a flash memory, a read only memory (ROM), and an erasable programmable read only memory (EPROM).

As described above, the radars 120 and 130 may be replaced or mixed with the Lidar 135 that scans the surroundings of the vehicle 1 and detects an object.

The individual components for implementing the present disclosure and the operation of each component have been described above. Hereinafter, operations for securing redundancy during autonomous driving will be described in detail based on the above-described components.

The present disclosure may be applied to a case in which an event occurs in at least one of the camera 110, the radars 120 and 130, and the Lidar 135 due to an internal factor or an external factor after generating a sensor fusion track for an object in an autonomous driving situation. In this case, the event indicates a state in which it is difficult to completely generate the sensor fusion track due to a failure in at least one of the camera 110, the radars 120 and 130, and the Lidar 135. For example, the controller 140 generates an event when a preceding object in front abruptly cuts out, when the movement of the preceding object in front is irregular, when it is difficult to secure a field of view because a foreign substance is attached to at least one of the camera 110, the radars 120 and 130, and the Lidar 135, when it is difficult for the camera 110 to secure an image due to low illumination, etc.

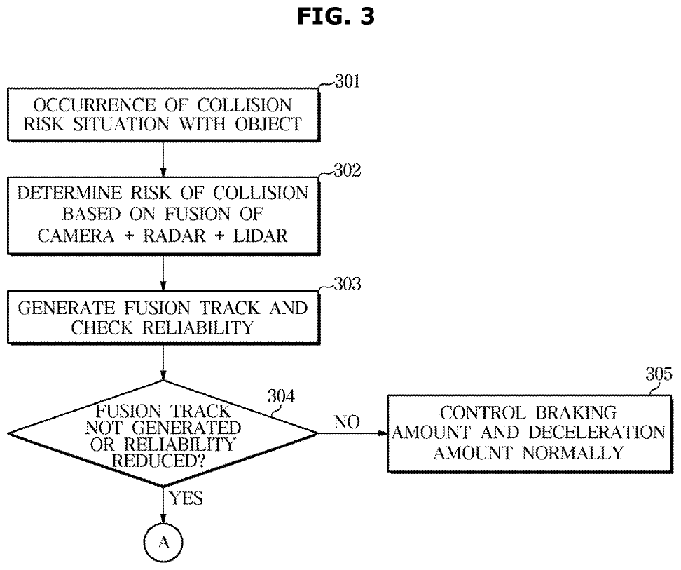

FIG. 3 is a flowchart of a control method of the vehicle according to an embodiment of the present disclosure.

When a collision risk situation with an object occurs (step 301), the controller 140 determines a risk of collision based on the camera 110, the radars 120 and 130, and the Lidar 135 (step 302).

In order to determine the risk of collision between the vehicle 1 and the object, the controller 140 generates a sensor fusion track and checks reliability of each sensor used to generate the sensor fusion track (step 303).

In this case, the reliability is a numerical value that quantitatively indicates how accurately the corresponding sensor recognizes the object (or lane), and may be determined based on a difference between a past measurement value and a current measurement value. In order to track an object, an association process that connects past track information and current measurement information is required, and a nearest neighborhood (NN) method may be used in the association process. A Kalman filter may be used to track an object, and the Kalman filter may receive measurement information and generate a current estimate based on past measurements.

The controller 140 may calculate the reliability based on a degree of similarity between lane information provided from the sensor fusion track and lane information provided from the navigation (or high definition map, HD map) in order to measure the reliability of at least one sensor.

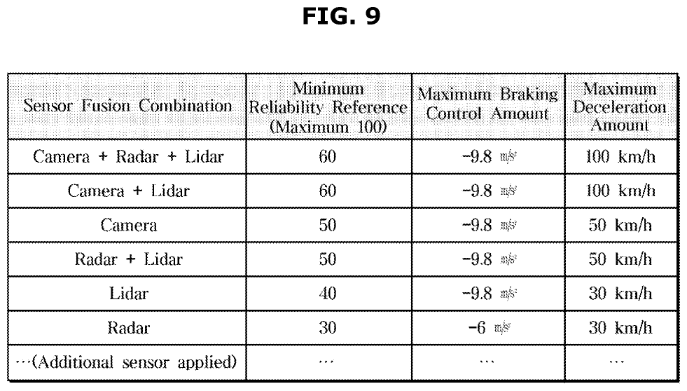

The controller 140 may calculate the reliability for each combination between the sensors and compare the reliability with a threshold that is a minimum reliability reference for each combination between the sensors. The controller 140 uses a sensor fusion track generated between the corresponding sensors only when the reliability satisfies a minimum reliability. Referring to FIG. 9, a minimum reliability for each sensor fusion combination and a control level corresponding thereto may be confirmed.

When a sensor fusion track is generated by all sensors, and the reliability of each of the camera 110, radars 120 and 130, and Lidar 135 satisfies a predetermined threshold, the controller 140 maintains an existing braking amount and a deceleration amount to perform normal control (step 305).

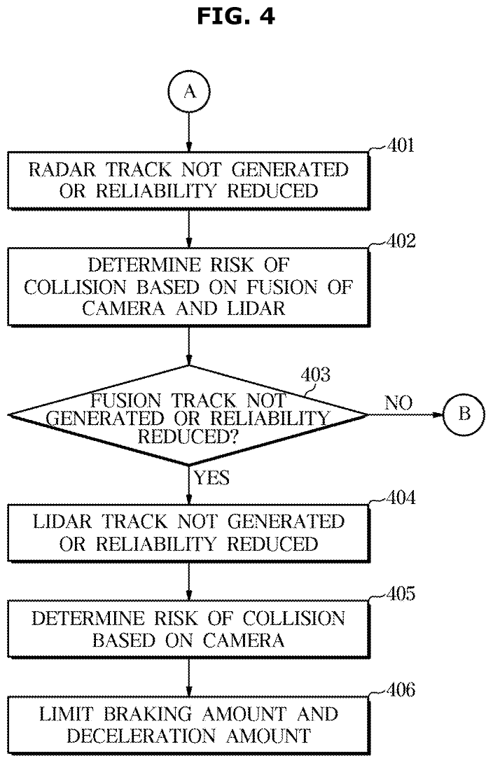

Alternatively, when a sensor fusion track is not generated, or if the reliability falls below the predetermined threshold (step 304), then the control method proceeds to FIG. 4.

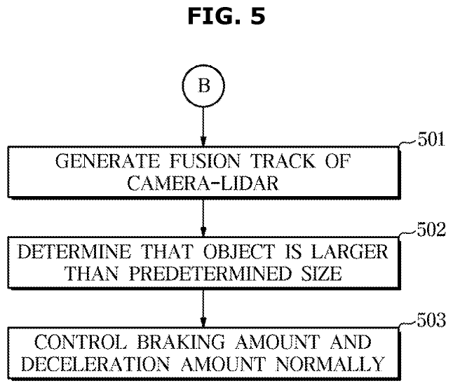

FIG. 4 is a flowchart of a control method of the vehicle in which the radars and the Lidar are excluded in the sensor fusion tracks, and FIG. 5 is a flowchart of a control method of the vehicle in which the radars are excluded in the sensor fusion tracks.

When it is detected that tracks by the radars 120 and 130 among the sensor fusion tracks are not generated or the reliability of the radars 120 and 130 is reduced (step 401), the controller 140 excludes the radars 120 and 130 in generating the sensor fusion tracks, determines the risk of collision based on the fusion of the camera 110 and the Lidar 135 (step 402).

In this case, the controller 140 may check again whether the sensor fusion track is suitable for driving control in a state in which the radars 120 and 130 are excluded. Specifically, when it is detected that the fusion track by the Lidar 135 is not generated in the sensor fusion tracks by the camera 110 and the Lidar 135 or the reliability of the Lidar 135 is reduced (steps 403 and 404), the controller 140 excludes the radars 120 and 130 and the Lidar 135 in generating the sensor fusion tracks, determines the risk of collision based on the camera 110 (step 405). In this case, the controller 140 may perform braking control or deceleration control based on image processing of the camera 110 without the sensor fusion track. Also, the controller 140 may generate the sensor fusion track by the camera 110 alone, and may perform the braking control or deceleration control based on the sensor fusion track.

The controller 140 may limit the braking amount and the deceleration amount when performing the braking control or deceleration control by the camera 110 alone. The controller 140 limits the braking amount and the deceleration amount when any one sensor is excluded from the sensor fusion track. That is, when the track of at least one sensor is excluded from the sensor fusion track, the controller 140 limits the braking amount and the deceleration amount. The correlation between the reliability, braking amount, and deceleration amount will be described later with reference to FIG. 9.

Referring to FIGS. 4 and 5, when it is detected that the tracks by the radars 120 and 130 among the sensor fusion tracks are not generated or the reliability of the radars 120 and 130 is reduced (step 401), the controller 140 excludes the radars 120 and 130 in generating the sensor fusion tracks, and determines the risk of collision based on the fusion of the camera 110 and the Lidar 135 (step 402). In this case, the controller 140 generates sensor fusion tracks based on the fusion of the camera 110 and the Lidar 135 (step 501).

Additionally, the controller 140 processes Lidar data in a case of the sensor fusion track including the Lidar 135 to identify a size of an object, and when it is determined that the size of the object is greater than or equal to a predetermined size (step 502), performs the braking control or deceleration control based on the sensor fusion track, and limits the braking amount and the deceleration amount.

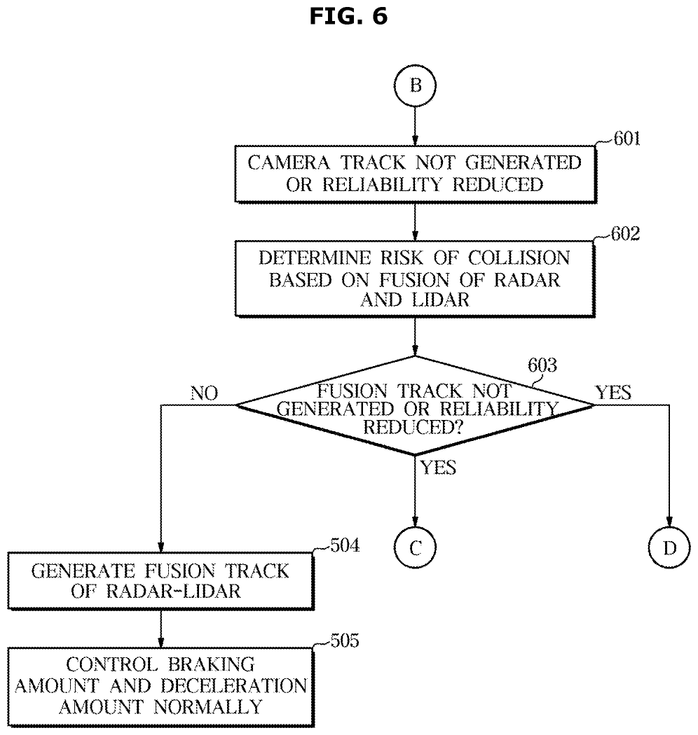

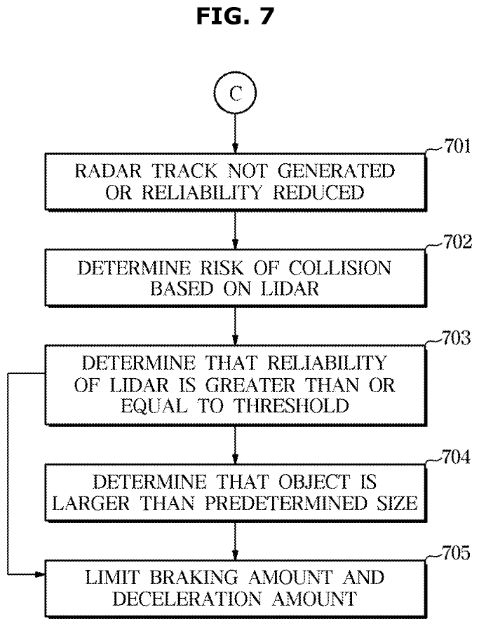

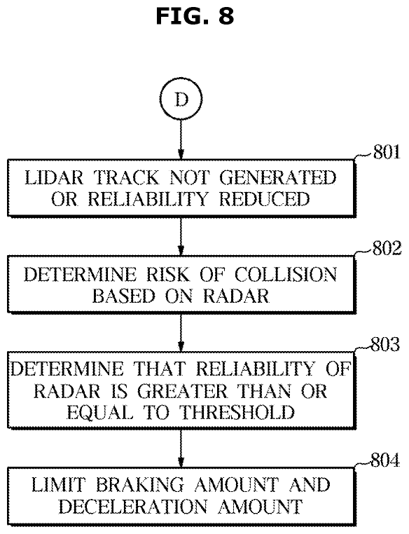

FIG. 6 is a flowchart of a control method of the vehicle in which the camera is excluded in the sensor fusion tracks, FIG. 7 is a flowchart of a control method of the vehicle in which the camera and the radars are excluded in the sensor fusion tracks, and FIG. 8 is a flowchart of a control method of the vehicle in which the camera and the Lidar are excluded in the sensor fusion tracks.

Referring to FIG. 6, when it is detected that the track by the camera 110 among the sensor fusion tracks is not generated or the reliability of the camera 110 is reduced (step 601), the controller 140 excludes the camera 110 in generating the sensor fusion tracks, and determines the risk of collision based on the fusion of the radars 120 and 130 and the Lidar 135 (step 602).

In this case, the controller 140 determines whether the fusion tracks by the radars 120 and 130 and the Lidar 135 are not generated or the reliability based on the radars 120 and 130 and the Lidar 135 is reduced (step 603).

When the reliability based on the radars 120 and 130 and the Lidar 135 is greater than or equal to the predetermined threshold, the controller 140 may generate a sensor fusion track based on the radar data and the Lidar data (step 504), and may preform the braking control or deceleration control based on the sensor fusion track. The controller 140 may limit the braking amount and the deceleration amount when performing the braking control or deceleration control by the radars 120 and 130 and the Lidar 135.

Referring to FIGS. 6 and 7, when it is detected that the fusion tracks by the radars 120 and 130 are not generated in the sensor fusion tracks by the radars 120 and 130 and the Lidar 135 or the reliability of the radars 120 and 130 is reduced (steps 604 and 701), the controller 140 excludes the radars 120 and 130 in generating the sensor fusion tracks, determines the risk of collision based on the Lidar 135 (step 702).

The controller 140 determines that the reliability of the Lidar 135 is greater than or equal to the predetermined threshold (step 703). The controller 140 may require higher reliability than when using a plurality of sensors due to the characteristic of relying on only the one Lidar 135.

Additionally, when the sensor fusion track based on the Lidar 135 is generated, the controller 140 determines whether an object is larger than the predetermined size (step 704). In addition, the controller 140 reflects the object on the sensor fusion track only when the object is larger than the predetermined size.

In this case, the controller 140 may perform the braking control or the deceleration control based on the Lidar data obtained from the Lidar 135 without the sensor fusion track. Also, the controller 140 may generate a sensor fusion track by the Lidar 135 alone, and may perform the braking control or the deceleration control based on the sensor fusion track.

The controller 140 may limit the braking amount and the deceleration amount when performing the braking control or the deceleration control by the Lidar 135 alone.

Referring to FIGS. 6 and 8, when it is detected that the fusion track by the Lidar 135 is not generated in the sensor fusion tracks by the radars 120 and 130 and the Lidar 135 or the reliability of the Lidar 135 is reduced (steps 604 and 801), the controller 140 excludes the Lidar 135 in generating the sensor fusion tracks, determines the risk of collision based on the radars 120 and 130 (step 802).

The controller 140 determines that the reliability of the radars 120 and 130 is greater than or equal to the predetermined threshold (step 803), and may perform the braking control or the deceleration control depending on the radar data only when the condition of step 803 is satisfied.

When the reliability of the radars 120 and 130 is greater than or equal to the predetermined threshold, the controller 140 may limit the braking amount and the deceleration amount.

That is, when an event occurs in any one sensor after the sensor fusion tracks are generated through the front camera 110, the radar 120 and 130, and the Lidar 135, the controller 140 generates a new sensor fusion track based on at least one sensor in which an event does not occur. The controller 140 determines whether a sensor in which an event does not occur satisfies a minimum reliability (threshold) in order to generate the new sensor fusion track. As the new sensor fusion track is generated, redundancy may be ensured in the sensor fusion.

As is apparent from the above, according to an aspect of the present disclosure, even when some of sensors fail to perform a function in a special situation during autonomous driving of a vehicle, the remaining sensors can operate as redundancy to increase reliability of autonomous driving.

The disclosed embodiments of the present disclosure may be implemented in the form of a recording medium storing instructions executable by a computer. The instructions may be stored in the form of program code, and when executed by a processor, a program module may be created to perform the operations of the disclosed embodiments of the present disclosure. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

The embodiments disclosed with reference to the accompanying drawings have been described above. It will be understood by those skilled in the art that various changes in form and details may be made therein without departing from the spirit and scope of the present disclosure as defined by the appended claims. The disclosed embodiments are illustrative and should not be construed as limiting.

What is claimed is:

1. A vehicle comprising:
a camera provided to obtain image data;
a radar provided to obtain radar data;
a Lidar provided to obtain Lidar data; and
a controller configured to process the image data, the radar data, and the Lidar data to generate a first sensor fusion track,
wherein the controller calculates reliability of at least one sensor in which an event does not occur among a plurality of sensors comprising the camera, the radar and the Lidar when the event for the at least one sensor is detected, and changes from the first sensor fusion track to a second sensor fusion track based on the at least one sensor when the reliability is greater than or equal to a predetermined threshold, and
wherein the controller is configured to control a braking amount or a deceleration amount of the vehicle based on the first sensor fusion track or the second sensor fusion track.

2. The vehicle according to claim 1, wherein the controller limits at least one of the braking amount or the deceleration amount of the vehicle to a predetermined ratio when the second sensor fusion track is generated.

3. The vehicle according to claim 1, wherein the controller detects an event for the camera and generates the second sensor fusion track based on a combination of the radar data and the lidar data with the highest reliability, maximum braking amount, and maximum deceleration amount.

3. The vehicle according to claim 1, wherein the controller detects an event for the camera and generates the second sensor fusion track based on the radar data and the Lidar data.

4. The vehicle according to claim 3, wherein the controller generates the event for the camera based on illuminance or external weather conditions.

5. The vehicle according to claim 1, wherein the controller detects an event for the radar and generates the second sensor fusion track based on the image data and the Lidar data.

6. The vehicle according to claim 5, wherein the controller occurs the event based on a connection state between the radar and the controller.

7. The vehicle according to claim 1, wherein the controller detects an event for the Lidar and generates the second sensor fusion track based on the image data and the radar data.

8. The vehicle according to claim 7, wherein the controller occurs the event based on a connection state between the radar and the controller.

9. The vehicle according to claim 1, wherein the controller detects an event for the camera and the radar, and generates the second sensor fusion track based on the Lidar data.

10. The vehicle according to claim 1, wherein the controller detects an event for the radar and the Lidar, and generates the second sensor fusion track based on the image data.

11. The vehicle according to claim 1, wherein the controller detects an event for the camera and the Lidar, and generates the second sensor fusion track based on the image data.

12. The vehicle according to claim 1, wherein the controller obtains a size of an object in front of the vehicle based on at least one of the image data and the Lidar data when the camera or the Lidar is included in the at least one sensor in which the event does not occur, and limits at least one of a braking amount and a deceleration amount of the vehicle to a predetermined ratio when the size of the object is greater than or equal to a predetermined size.

13. The vehicle according to claim 1, wherein the controller performs avoidance control for an object based on the second sensor fusion track.

14. The vehicle according to claim 1, wherein the event comprises a situation in which a preceding vehicle traveling in a field of front view of the vehicle disappears and an object in front of the preceding vehicle is detected.

15. A control method of a vehicle which comprises a camera provided to obtain image data, a radar provided to obtain radar data, and a Lidar provided to obtain Lidar data, the control method comprising:
processing, by a controller, the image data, the radar data, and the Lidar data to generate a first sensor fusion track;
detecting, by the controller, an event for at least one of a plurality of sensors comprising the camera, the radar and the Lidar;
calculating, by the controller, reliability of at least one sensor among the plurality of sensors in which the event does not occur; and
changing, by the controller, from the first sensor fusion track to a second sensor fusion track based on the at least one sensor when the reliability is greater than or equal to a predetermined threshold; and
controlling, by the controller, a braking amount or a deceleration amount of the vehicle based on the first sensor fusion track or the second sensor fusion track.

16. The control method according to claim 15, further comprising:
limiting at least one of the braking amount or the deceleration amount of the vehicle to a predetermined ratio when the second sensor fusion track is generated.

17. The control method according to claim 15, wherein changing from the first sensor fusion track to the second sensor fusion track comprises detecting an event for the camera and generating the second sensor fusion track based on the radar data and the Lidar data.

18. The control method according to claim 17, wherein detecting the event for the camera comprises generating an event for the camera based on illuminance or external weather conditions.

19. The control method according to claim 15, wherein changing from the first sensor fusion track to the second sensor fusion track comprises detecting an event for the radar and generating the second sensor fusion track based on the image data and the Lidar data.

20. The control method according to claim 19, wherein detecting the event for the radar comprises detecting the event based on a connection state between the radar and a controller.

21. A non-transitory computer readable medium containing program instructions executed by a processor, the computer readable medium comprising:
program instructions that process image data, radar data, and Lidar data to generate a first sensor fusion track;
program instructions that detect an event for at least one of a plurality of sensors comprising a camera, a radar and a Lidar;
program instructions that calculate reliability of at least one sensor among the plurality of sensors in which the event does not occur;
program instructions that change from the first sensor fusion track to a second sensor fusion track based on the at least one sensor when the reliability is greater than or equal to a predetermined threshold; and
program instructions that control a braking amount or a deceleration amount of the vehicle based on the first sensor fusion track or the second sensor fusion track.
